(19) United States
(12) Patent Application Publication
(10) Pub. No.: US 2017/0174226 A1
(43) Pub. Date: Jun. 22, 2017

(54) CONFIGURATION ADJUSTMENT SYSTEM OF PERSONAL VEHICLE AND METHOD THEREOF

(71) Applicants: Inventec (Pudong) Technology Corporation, Shanghai (CN); Inventec Corporation, Taipei City (TW)

(72) Inventor: Wei Fang Zhang, Shanghai (CN)

(21) Appl. No.: 15/380,260

(22) Filed: Dec. 15, 2016

(30) Foreign Application Priority Data
Dec. 18, 2015 (CN) 201510961107.7

(51) Int. Cl. B60W 50/00

(52) U.S. Cl. CPC B60W 50/0098; B60W 2540/28

(57) ABSTRACT

The present invention illustrates a configuration adjustment system of personal vehicle and a method thereof. In the system, a client can transmit vehicle hardware information and personal identity information to a server via an in-vehicle computer. The server obtains personalization vehicle configuration parameter information and vehicle hardware configuration adjustment parameter information according to the first vehicle hardware information and the personal identity information, and then adjusts vehicle hardware configuration adjustment parameter information according to the personalization vehicle configuration parameter information to generate and return first vehicle hardware adjustment parameter information to the first in-vehicle computer. The first in-vehicle computer adjusts the hardware configuration of a first vehicle according to the first vehicle hardware adjustment parameter information. Therefore, the technical effect of automatically adjusting vehicle hardware to meet the driver's requirement before driving can be achieved.

### CROSS-REFERENCE TO RELATED APPLICATION

This application claims the benefit of Chinese Patent Application No. 201510961107.7, filed Dec. 18, 2015.

### BACKGROUND OF THE INVENTION

Field of the Invention

The present invention relates to a configuration adjustment system of personal vehicle and method thereof, particularly related to a configuration adjustment system of personal vehicle adjusts a hardware configuration of a vehicle though the server providing vehicle hardware adjustment parameter information.

Description of the Related Art

A driver usually adjusts vehicle hardware upon his own demand before driving a vehicle, for example, the vehicle hardware adjustment includes adjustment of a height and an angle of a car seat, adjustment of a height of a steering wheel, adjustment of an angle of a rear-view mirror, and so on. Because different drivers have different personal physiological feature, each driver must repeatedly adjust the vehicle hardware while driving different vehicles, and it really causes inconvenience for the driver in driving vehicle.

In conclusion, the problem that the driver must repeatedly adjust the vehicle hardware while driving different vehicles exists in the conventional technology for a long-term period. What is need is to provide an improved technology solution to solve this problem.

### SUMMARY OF THE INVENTION

In order to solve the problems that a driver must repeatedly adjust vehicle hardware in advance while driving different vehicles, the present invention provides a configuration adjustment system of personal vehicle and a method thereof.

The configuration adjustment system of personal vehicle includes a first in-vehicle computer and a server, and the server further includes a storage module, a transmission module, a search module and a processing module.

The first in-vehicle computer disposing in a first vehicle and storing first vehicle hardware information. Upon receipt of personal identity information, the first in-vehicle computer transmits the first vehicle hardware information and the personal identity information, and upon receipt of first vehicle hardware adjustment parameter information the first in-vehicle computer adjusts a hardware configuration of the first vehicle according to the first vehicle hardware adjustment parameter information.

The storage module, storing a common vehicle configuration parameter database and a client personal database. The transmission module, receiving the first vehicle hardware information and the personal identity information from the first in-vehicle computer, and transmitting the first vehicle hardware adjustment parameter information to the first in-vehicle computer. The search module, obtaining a personal physiological feature and personalization vehicle configuration parameter information according to the first vehicle hardware information from the client personal database, and obtaining vehicle hardware configuration adjustment parameter information according to the personal physiological feature and the vehicle hardware information from the common vehicle configuration parameter database. The processing module, adjusting the vehicle hardware configuration adjustment parameter information according to the personalization vehicle configuration parameter information for generating the first vehicle hardware adjustment parameter information, and storing the first vehicle hardware adjustment parameter information to the storage module to update the vehicle hardware configuration adjustment parameter information.

The present invention further provides a personal vehicle configuration adjustment method including following steps: providing a first in-vehicle computer in a first vehicle and storing first vehicle hardware information in the first in-vehicle computer; receipting personal identity information by the first in-vehicle computer, using the first in-vehicle computer to transmit the first vehicle hardware information and the personal identity information to a server; storing a common vehicle configuration parameter database and a client personal database in the server; obtaining a personal physiological feature and personalization vehicle configuration parameter information according to the first vehicle hardware information from the client personal database of the server, and obtaining vehicle hardware configuration adjustment parameter information according to the personal physiological feature and the first vehicle hardware information from the common vehicle configuration parameter database of the server; adjusting the vehicle hardware configuration adjustment parameter information according to the personalization vehicle configuration parameter information for generating the first vehicle hardware adjustment parameter information by the server, and storing the first vehicle hardware adjustment parameter information to update the vehicle hardware configuration adjustment parameter information by the server; transmitting the first vehicle hardware adjustment parameter information from the server to the first in-vehicle computer; adjusting a hardware configuration of the first vehicle according to the first vehicle hardware adjustment parameter information by the first in-vehicle.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 is a system block diagram of a configuration adjustment system of personal vehicle of the present invention.

FIGS. 2A-2F are flow charts of a personal vehicle configuration adjustment method of the present invention.

FIG. 3 is a schematic structural diagram of the configuration adjustment system of personal vehicle of the present invention.

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

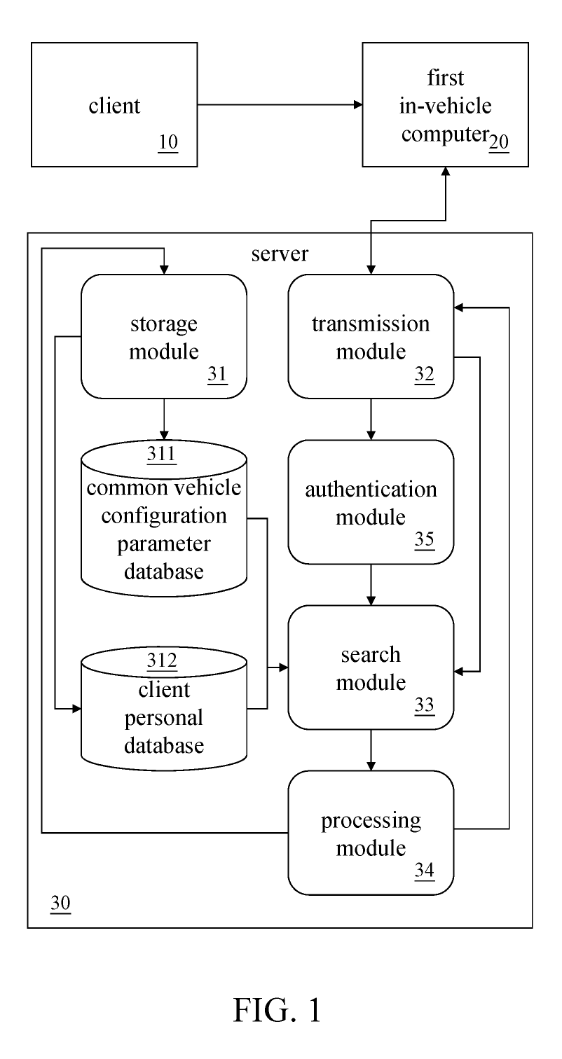

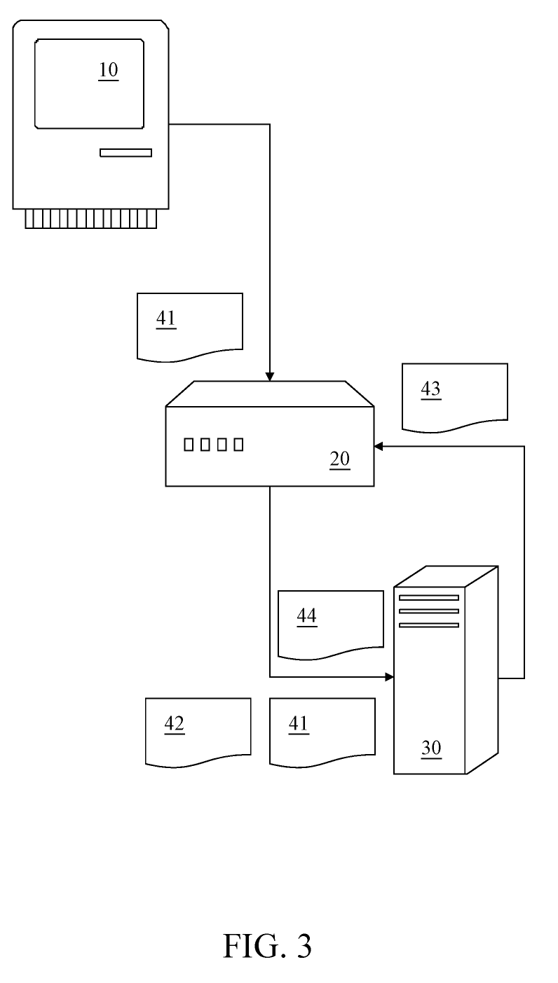

In following content an embodiment is taken as an example to illustrate an operation system and method thereof in accordance with a first implementation aspect of the present invention. Please refer to FIGS. 1, 2A-2F, and 3 which are system block diagram of a configuration adjustment system of personal vehicle, flow charts of a personal vehicle configuration adjustment method, and schematic structural view of the configuration adjustment system of personal vehicle, in accordance with the present invention, respectively.

The configuration adjustment system of personal vehicle includes a first in-vehicle computer 20 and a server 30. The server 30 includes a storage module 31, a transmission module 32, a search module 33 and a processing module 34.

The first in-vehicle computer 20 is disposed in a first vehicle and stores first vehicle hardware information (step 101). Receipting personal identity information by the first in-vehicle computer 20, the first in-vehicle computer 20 transmits the first vehicle hardware information 42 and the personal identity information 41 to the server 30 by a wireless transmission manner (step 102). The first vehicle hardware information 42 includes first vehicle type data (such as Toyota wish, BMW m3, Mercedes-Benz c200, and so on, but the present invention is not limited thereto), at least one first vehicle fittings type data (such as steering wheel, rear-view mirror, car seat and so on, but the present invention is not limited thereto), and a first current vehicle fittings configuration parameter (such as a height of the steering wheel, an angle of the rear-view mirror, a location of car seat, and so on, but the present invention is not limited thereto. Preferably, the wireless transmission manner includes wireless network, Wi-Fi and so on, but the present invention is not limited thereto.

It is worth noting that the personal identity information is stored in a client 10, when the client 10 approaches the first in-vehicle computer disposed in the first vehicle, the client 10 can establish interconnection with the first in-vehicle computer 20 by the wireless transmission manner, and then transmit the personal identity information 41 to the first in-vehicle computer 20, and the first in-vehicle computer 20 can receive the personal identity information 41 from the client 10. Preferably, the wireless transmission manner includes Wi-Fi, Bluetooth, and so on, the client 10 includes a portable device and a wearable device, but the present invention is not limited thereto.

In the server 30, a common vehicle configuration parameter database 311 and a client personal database 312 is stored in the storage module 31 (step 103), and the transmission module 32 can receive the first vehicle hardware information 42 and the personal identity information 41 from the first in-vehicle computer 20.

From client personal database 312, the search module 33 of the server 30 obtains a personal physiological feature (such as a height, a weight, measurements, and so on, but the present invention is not limited thereto) and personalization vehicle configuration parameter information (such as the height of the steering wheel, the angle of the rear-view mirror, the location and an angle of the car seat, and so on, but the present invention is not limited thereto) according to the first vehicle hardware information 42, and from the common vehicle configuration parameter database 311, the search module 33 obtains the vehicle hardware configuration adjustment parameter information (such as the height of the steering wheel, the angle of the rear-view mirror, the location of the car seat, the angle of the car seat, but the present invention is not limited thereto) according to a search condition including the personal physiological feature and the first vehicle hardware information 42 (step 104).

After the search module 33 of the server 30 obtains the personalization vehicle configuration parameter information and the vehicle hardware configuration adjustment parameter information, the processing module 34 of the server 30 adjusts the vehicle hardware configuration adjustment parameter information according to the personalization vehicle configuration parameter information, to generate first vehicle hardware adjustment parameter information 43 (such as the height of the steering wheel, the angle of the rear-view mirror, the location of the car seat, the angle of the car seat, and so on, but the present invention is not limited thereto)(step 105).

After adjusting the vehicle hardware configuration adjustment parameter information according to the personalization vehicle configuration parameter information to generate the first vehicle hardware adjustment parameter information 43, the processing module 34 of the server 30 further provides the first vehicle hardware adjustment parameter information 43 to the storage module 21 of the server 30 to update the vehicle hardware configuration adjustment parameter information corresponding to the personal physiological feature and the first vehicle hardware information (step 105). Therefore, during the user operates the first vehicle, the server 30 can store a great amount of first vehicle hardware information generated according to the user's personal physiological feature, to continuously update the vehicle hardware configuration adjustment parameter information, so that the most ergonomic vehicle hardware configuration can be obtained.

The transmission module 32 of the server 30 transmits the first vehicle hardware adjustment parameter information generated by the processing module 34, to the first in-vehicle computer 20 by the wireless transmission manner (step 106). After receiving the first vehicle hardware adjustment parameter information 43 from the transmission module 32 of the server 30, the first in-vehicle computer 20 adjusts the hardware configuration of the first vehicle according to the first vehicle hardware adjustment parameter information 43 (step 107). For example, the first in-vehicle computer 20 adjusts the height of the steering wheel, the angle of the rear-view mirror, the location of car seat and so on, according to the first vehicle hardware adjustment parameter information 43, but the present invention is not limited thereto. Therefore, the hardware configuration of the first vehicle can fit the driver holding the client 10.

It is worth noting that from the common vehicle configuration parameter database 311 the search module 33 can base the first vehicle hardware information to search the second vehicle hardware information which contains at least on same vehicle hardware information with the first vehicle hardware information when the search module 33 of the server 30 fails to obtain the vehicle hardware configuration adjustment parameter information according to the personal physiological feature and the first vehicle hardware information from the common vehicle configuration parameter database 311 (step 201). That is, the first vehicle hardware information and the second vehicle hardware information both include at least one the same vehicle hardware information. Particularly, the search module 33 of the server 30 can use vehicle hardware information of the first vehicle hardware information as a search condition to search the second vehicle hardware information which has the most amount of vehicle hardware information the same as that of the first vehicle hardware information. Next, from the common vehicle configuration parameter database 311, the search module 33 of the server 30 obtains the vehicle hardware configuration adjustment parameter information according to the personal physiological feature and the second vehicle hardware information (step 202).

When the first in-vehicle computer 20 detects that the hardware configuration of the first vehicle is adjusted, the first in-vehicle computer 20 generates first vehicle configuration change parameter information 44 (step 203). After the first in-vehicle computer 20 generates the first vehicle configuration change parameter information 44, the first vehicle configuration fluctuate parameter information 44 is transmitted to the server 30 by the wireless transmission manner (step 204).

Next, the transmission module 32 of the server 30 receives the first vehicle configuration change parameter information 44 from the first in-vehicle computer 20, and then according to the first vehicle configuration change parameter information, the storage module 31 of the server 30 updates the vehicle hardware configuration adjustment parameter information corresponding to the personal physiological feature and the first vehicle hardware information, so as to update the data of the vehicle configuration parameter database stored in the server (step 205).

The server 30 further includes an authentication module 35. After the transmission module 32 of the server 30 receives the first vehicle hardware information 42 and the personal identity information 41 from the first in-vehicle computer 20, the authentication module 35 of the server 30 compares the personal identity information 41 with an authentication form to authenticating identity (step 206). When the personal identity information 41 is matched with one of authentication information contained in the authentication form, from the client personal database 312 the search module 33 of the server 30 obtains the personal physiological feature and the personalization vehicle configuration parameter information according to the first vehicle hardware information 42, and from the common vehicle configuration parameter database 311 the search module 33 further obtains the vehicle hardware configuration adjustment parameter information according to the personal physiological feature and the first vehicle hardware information (that is, the step 104 is executed).

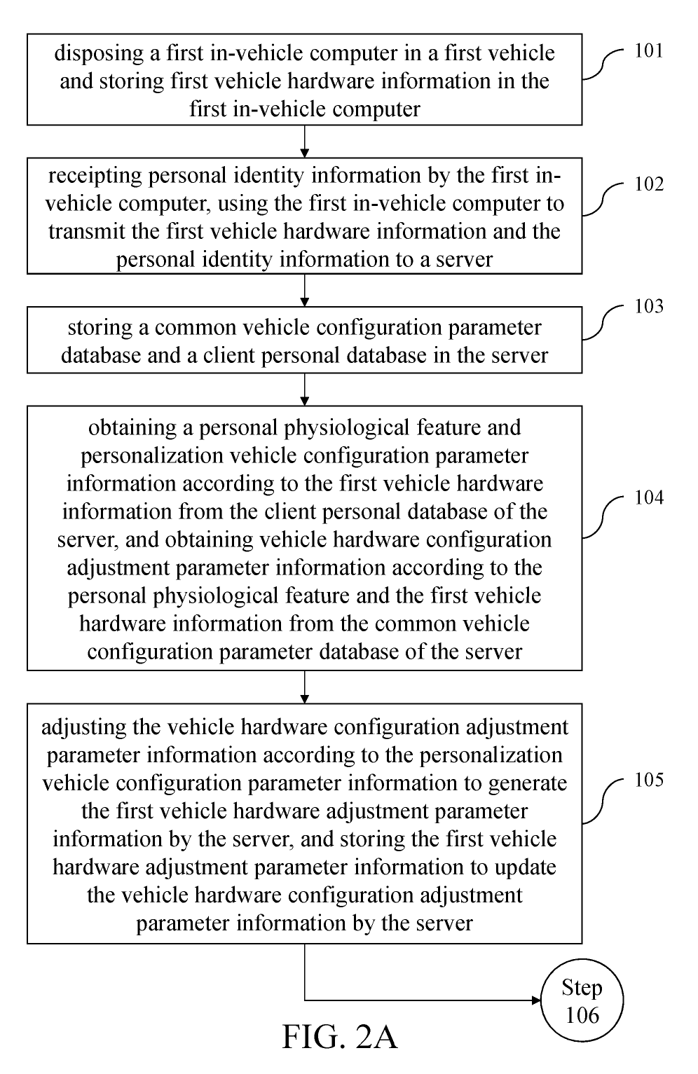

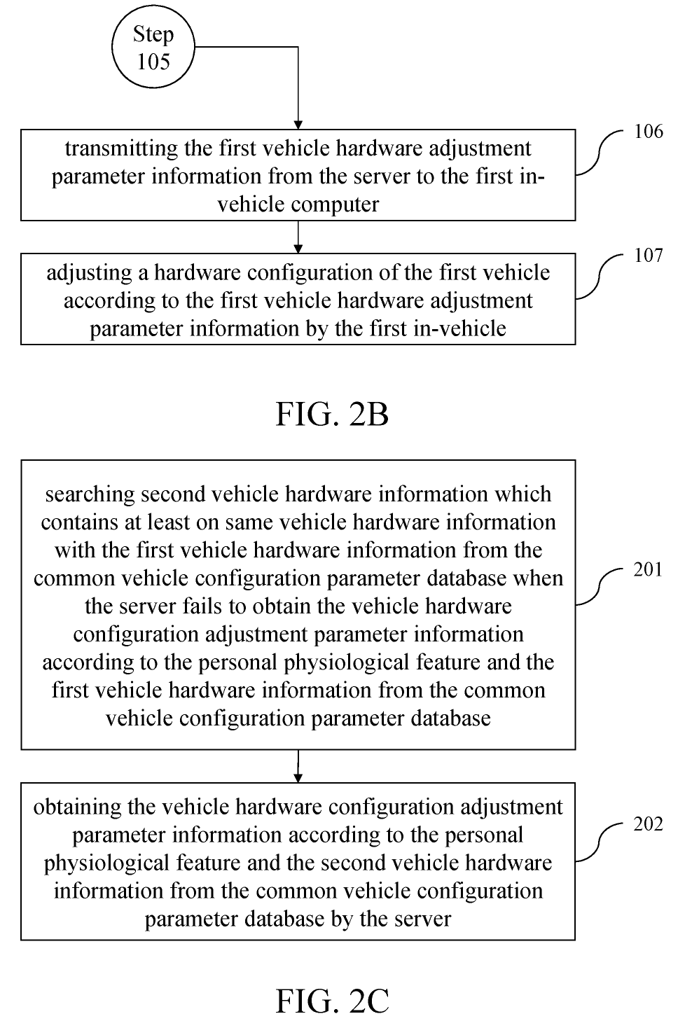

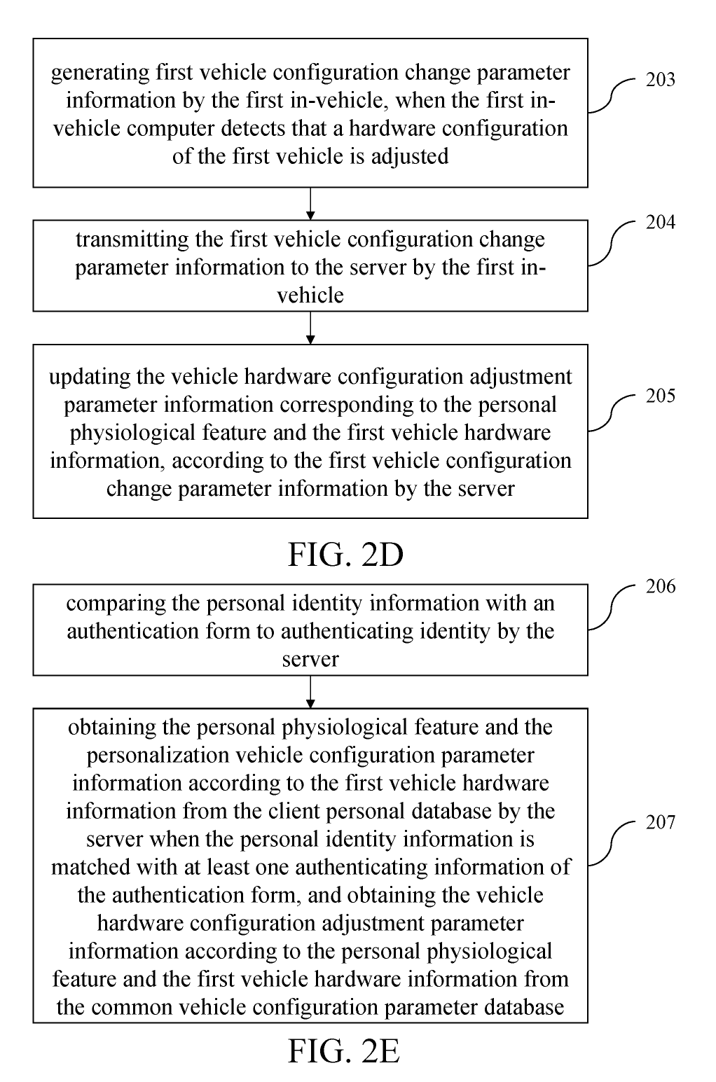

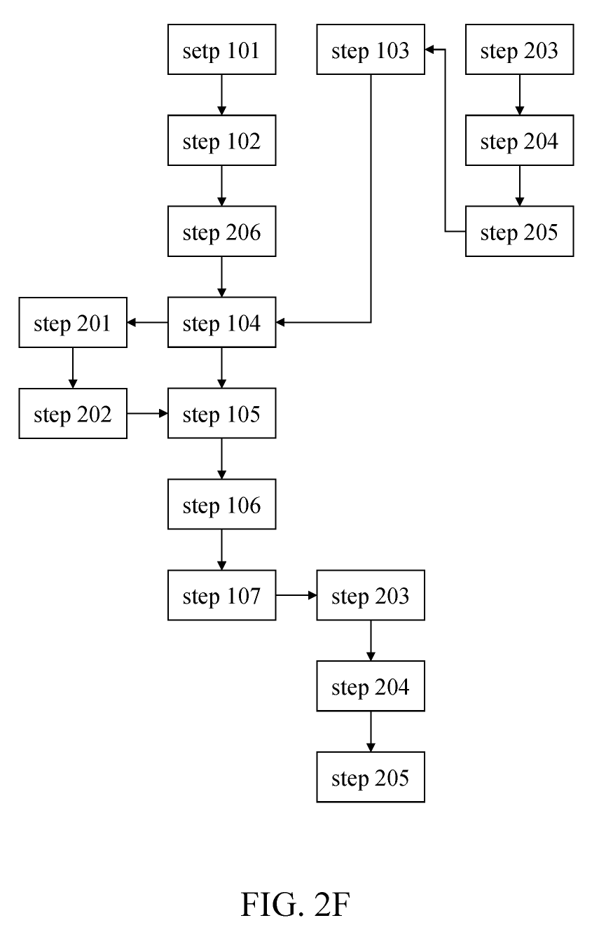

FIG. 2E shows one of embodiment modes of flow combination between aforesaid steps, but the embodiment mode shown in FIG. 2E is just taken as an example and the present invention is not limited thereto. The contents of all steps shown in FIG. 2E can be found in that of corresponding steps shown in FIGS. 2A-2D, so their detailed descriptions and drawings are omitted.

In conclusion, the difference between the conventional technology and the present invention is that from the common vehicle configuration parameter database the present invention obtains the vehicle hardware configuration adjustment parameter information according to the personal physiological feature and the first vehicle hardware information, and adjusts the vehicle hardware configuration adjustment parameter information according to the personalization vehicle configuration parameter information to generate the first vehicle hardware adjustment parameter information for adjustment of the hardware configuration of the first vehicle, so that the driver can avoid from repeatedly adjusting the vehicle configurations while driving different vehicles.

By means of aforesaid technology, the present invention can solve the problem that the driver must repeatedly adjust the vehicle hardware for driving different vehicles, and achieve a technology effect of automatically adjusting the vehicle hardware to meet the driver's demand before the drive drives the vehicle.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A configuration adjustment system of personal vehicle, comprising:
a first in-vehicle computer disposing in a first vehicle and storing a first vehicle hardware information wherein upon receipt of personal identity information the first in-vehicle computer transmits the first vehicle hardware information and the personal identity information, and upon receipt of first vehicle hardware adjustment parameter information the first in-vehicle computer adjusts a hardware configuration of the first vehicle according to the first vehicle hardware adjustment parameter information; and
a server, comprising:
a storage module, storing a common vehicle configuration parameter database and a client personal database;
a transmission module, receiving the first vehicle hardware information and the personal identity information from the first in-vehicle computer, and transmitting the first vehicle hardware adjustment parameter information to the first in-vehicle computer;
a search module, obtaining a personal physiological feature and personalization vehicle configuration parameter information according to the first vehicle hardware information from the client personal database, and obtaining a vehicle hardware configuration adjustment parameter information according to the personal physiological feature and the vehicle hardware information from the common vehicle configuration parameter database; and
a processing module, adjusting the vehicle hardware configuration adjustment parameter information according to the personalization vehicle configuration parameter information to generate the first vehicle hardware adjustment parameter information, and storing the first vehicle hardware adjustment parameter information to the storage module to update the vehicle hardware configuration adjustment parameter information.

2. The configuration adjustment system of personal vehicle according to claim 1, wherein when the search module fails to obtain the vehicle hardware configuration adjustment parameter information according to the personal physiological feature and the first vehicle hardware information from the common vehicle configuration parameter database, the search module searches second vehicle hardware information which contains at least one same vehicle hardware information with the first vehicle hardware information from the common vehicle configuration parameter database, and the search module obtains the vehicle hardware configuration adjustment parameter information according to the personal physiological feature and the second vehicle hardware information from the common vehicle configuration parameter database.

3. The configuration adjustment system of personal vehicle according to claim 1, wherein when the first in-vehicle computer detects that the hardware configuration of the first vehicle is adjusted, the first in-vehicle computer generates first vehicle configuration change parameter information, and transmits the first vehicle configuration change parameter information to the server, and the storage module of the server updates the vehicle hardware configuration adjustment parameter information corresponding to the personal physiological feature and the first vehicle hardware information according to the first vehicle configuration change parameter information.

4. The configuration adjustment system of personal vehicle according to claim 1, wherein the first vehicle hardware information comprises first vehicle type data, at least one first vehicle fittings type data, and a first vehicle current fittings configuration parameter.

5. The configuration adjustment system of personal vehicle according to claim 1, wherein the server further comprises an authentication module, the authentication module comparing the personal identity information with an authentication form for authenticating identity, and the search module obtains the personal physiological feature and the personalization vehicle configuration parameter information according to the first vehicle hardware information from the client personal database when the personal identity information is matched with at least one of authenticating information of the authentication form, and obtains the vehicle hardware configuration adjustment parameter information according to the personal physiological feature and the first vehicle hardware information from the common vehicle configuration parameter database.

6. The configuration adjustment system of personal vehicle according to claim 1, further comprising a client, the client storing the personal identity information, and the client comprising a portable device and a wearable device.

7. A personal vehicle configuration adjustment method, comprising
providing a first in-vehicle computer in a first vehicle and storing first vehicle hardware information in the first in-vehicle computer;
receipting personal identity information by the first in-vehicle computer, using the first in-vehicle computer to transmit the first vehicle hardware information and the personal identity information to a server;
storing a common vehicle configuration parameter database and a client personal database in the server;
obtaining a personal physiological feature and personalization vehicle configuration parameter information according to the first vehicle hardware information from the client personal database of the server, and obtaining vehicle hardware configuration adjustment parameter information according to the personal physiological feature and the first vehicle hardware information from the common vehicle configuration parameter database of the server;
adjusting the vehicle hardware configuration adjustment parameter information according to the personalization vehicle configuration parameter information to generate the first vehicle hardware adjustment parameter information by the server, and storing the first vehicle hardware adjustment parameter information to update the vehicle hardware configuration adjustment parameter information by the server;
transmitting the first vehicle hardware adjustment parameter information from the server to the first in-vehicle computer; and
adjusting a hardware configuration of the first vehicle according to the first vehicle hardware adjustment parameter information by the first in-vehicle.

8. The personal vehicle configuration adjustment method according to claim 7, further comprising:
searching second vehicle hardware information which contains at least one same vehicle hardware information with the first vehicle hardware information from the common vehicle configuration parameter database when the server fails to obtain the vehicle hardware configuration adjustment parameter information according to the personal physiological feature and the first vehicle hardware information from the common vehicle configuration parameter database; and
obtaining the vehicle hardware configuration adjustment parameter information according to the personal physiological feature and the second vehicle hardware information from the common vehicle configuration parameter database by the server.

9. The personal vehicle configuration adjustment method according to claim 7, further comprising:
generating first vehicle configuration change parameter information by the first in-vehicle, when the first in-vehicle computer detects that a hardware configuration of the first vehicle is adjusted;
transmitting the first vehicle configuration change parameter information to the server by the first in-vehicle; and
updating the vehicle hardware configuration adjustment parameter information corresponding to the personal physiological feature and the first vehicle hardware information according to the first vehicle configuration change parameter information by the server.

10. The personal vehicle configuration adjustment method according to claim 7, in the step of providing the in-vehicle computer in the first vehicle and storing the first vehicle hardware information in the first in-vehicle computer, wherein the first vehicle hardware information comprises first vehicle type data, at least one first vehicle fittings type data and a first current vehicle fittings configuration parameter

11. The personal vehicle configuration adjustment method according to claim 7, further comprising:
comparing the personal identity information with an authentication form to authenticating identity by the server; and
obtaining the personal physiological feature and the personalization vehicle configuration parameter information according to the first vehicle hardware information from the client personal database by the server when the personal identity information is matched with at least one authenticating information of the authentication form, and obtaining the vehicle hardware configuration adjustment parameter information according to the personal physiological feature and the first vehicle hardware information from the common vehicle configuration parameter database.

12. The personal vehicle configuration adjustment method according to claim 7, in the step of receiving the personal identity information in the first in-vehicle computer, wherein the personal identity information is stored in a client which comprises a portable device and a wearable device.
